(19) United States
(12) Patent Application Publication
(10) Pub. No.: US 2013/0263081 A1
(43) Pub. Date: Oct. 3, 2013

(54) MODEL EDITING ASSISTANCE DEVICE, MODEL EDITING ASSISTANCE METHOD, AND MODEL EDITING ASSISTANCE PROGRAM

(71) Applicant: Sayaka Izukura, Minato-ku (JP)

(72) Inventor: Sayaka Izukura, Minato-ku (JP)

(73) Assignee: NEC CORPORATION, Minato-ku, Tokyo (JP)

(21) Appl. No.: 13/991,509

(22) PCT Filed: Nov. 30, 2011
(86) PCT No.: PCT/JP2011/006700

§ 371 Date: Jun. 4, 2013

(30) Foreign Application Priority Data
Dec. 9, 2010 (JP) 2010-274655

(51) Int. Cl. G06F 9/44

(52) U.S. Cl. CPC G06F 8/35
USPC 717/104

(57) ABSTRACT

There are provided repetitively referenced class determining means for determining whether or not there are similar elements which are elements referring to the same class and having different attributes or attribute values in an input model description; common class attribute extracting means for extracting an attribute shared by the similar elements extracted in accordance with a result of the determination as a common class attribute of a group comprising the similar elements; derived class generating means for generating derived classes inheriting the common class attribute and associating the derived classes with their respective extracted similar elements; attribute value determining means for setting concrete attribute values of the generated derived classes at values which are described as attribute values of the corresponding similar elements; and referenced class replacing means for replacing the class referred to by the extracted similar elements with the derived classes, the concrete attribute values of which have been set.

### TECHNICAL FIELD

The present invention relates to a model editing assistance device, a model editing assistance method and a model editing assistance program which are used for aiding modeling making use of a modeling language called UML2.

### BACKGROUND ART

In recent years, in order to design and/or develop a system or the like with a high degree of efficiency, there are widely used a number of model editors (modeling tools) for describing UML (Unified Modeling Language, a registered trademark) and SysML (System Modeling Language) with ease. It is to be noted that SysML is a domain characteristic modeling language defined as a UML2.0 profile for system engineering. In addition, in the form of a profile on the specifications of UML, a variety of extended notations specific to a variety of domains (object areas) are made.

When carrying out modeling adopting an extended notation according to a meta model of UML2, however, a problem may be raised if the described range is extended or limited. In the case of SysML for example, when a property having a nesting structure is described, it is hard to say that the model structure is expressed with a high degree of accuracy from a drawing notation point of view. Thus, when describing a model by making use of a variety of tools referred to as model editors, an operation cannot be carried out as intended or an incorrect model different from a structure originally described is undesirably described.

For example, UML2 is used to prescribe a composite structure drawing expressing the structure of a small part such as a class or a component or a collaboration used in it. In the composite structure drawing, a boundary between an internal structure and an external structure is expressed clearly by making use of a “port” and an internal configuration element is expressed by making use of a “part”. In addition, a relation between a part and a port and a relation between parts are expressed by making use of “connectors”. In this case, when describing another part (also referred to as a part property) “b” or a value property “c” inside a certain part property “a” in an internal block drawing, at a position above the drawing, the part “b” or the value property “c” looks like a child of the part “a”. In this case, the part property is a property showing an internal element. In the following description, the part property is also referred to as a part. On the other hand, the value property is a property showing a value. In the following description, the value property is also referred to as a value. In the case of such descriptions, however, in a model structure, the part b and the value c are children of a class A of a type referring to the part a. That is to say, if another part a′ referring to a class A in another drawing is described, a part b and a value c which serve as attributes of the part are added automatically so that, by merely looking at the internal block drawing, the structure of such a SysML model is difficult to understand.

Thus, in some cases, an incorrect drawing may be described in which, inside the other part a′ referring to a class A in another drawing, another part d and/or a value c′ having a different value are included.

Depending on the modeling tool, control may be executed in order to disable an operation to draw a drawing having the incorrect structure described above. If the model maker is not well versed in the structure of the SysML model, however, confusion will be resulted in.

Non-Patent Document 1 discloses a typical method for describing different attributes for a plurality of parts referring to such a common class. In accordance with the method disclosed in Non-Patent Document 1, in order to describe different attributes for a plurality of parts referring to a common class, it is necessary to set an instance of the common class for which a concrete attribute value is described as an initial value of the part.

If a plurality of components having a common property (or a common attribute), that is, having a common type are described as parts for example, the concrete attribute value of the parts varies from component to component. Thus, only the type of the attribute is described in advance in the class serving as the type whereas, for the instance of the class, the concrete attribute value is set. Then, by setting the instance as an initial value of a part, it is possible to set different attribute values for the parts.

### CITATION LIST

### Non-Patent Literature

Non-Patent Document 1
Sanford Friedenthal, Alan Moore and Rick Steiner, “A Practical Guide to SysML: The System Modeling Language,” The MK/OMG Press, (US), Aug. 7, 2008, p. 134-144

### SUMMARY OF INVENTION

### Technical Problem

However, every time parts referring to the same class are described, it takes time and labor to carry out the operations described above. In addition, it is difficult for a model maker who does not know details of SysML to carry out the complicated operations described above.

On top of that, from a drawing of SysML, it is difficult to understand the structure of a model and, since the drawing description intended by the model maker does not match the actual structure of the model, there is raised an unsolved problem that an incorrect model is described undesirably.

In order to solve the problem, it is an object of the present invention to provide a model editing assistance device, a model editing assistance method and a model editing assistance program which enable even a model maker not well versed in a modeling language such as SysML to construct a model having a correct structure while reducing a load borne by the model maker.

### Solution to Problem

A model editing assistance device according to the present invention is a model editing assistance device for aiding modeling making use of a modeling language. The model editing assistance device is characterized in that the model editing assistance device comprises: repetitively referenced class determining means for determining whether or not there are similar elements which are elements referring to the same class and having different attributes or attribute values in an input model description; common class attribute extracting means for extracting an attribute shared by the similar elements extracted in accordance with a result of the determination carried out by the repetitively referenced class determining means to serve as a common class attribute of a group comprising the similar elements; derived class generating means for generating derived classes inheriting the common class attribute extracted by the common class attribute extracting means and associating the derived classes with their respective extracted similar elements; attribute value determining means for setting concrete attribute values of the derived classes generated by the derived class generating means at values which are described as attribute values of the corresponding similar elements; and referenced class replacing means for replacing the class referred to by the extracted similar elements with the derived classes, the concrete attribute values of which have been set by the attribute value determining means.

In addition, the model editing assistance device according to the present invention may be characterized in that the model editing assistance device comprises: predefined attribute searching means for searching for a predefined attribute which is an attribute defined in advance for a certain referenced class when describing an element referring to the class; subclass generating means for generating a subclass of a certain referenced class when changing the value of the predefined attribute included in attributes of elements referring to the referenced class in a model description to serve as an attribute of the referenced class; and model element generating means for generating a model element referring to a subclass generated by the subclass generating means for a described element.

A model editing assistance method according to the present invention is a model editing assistance method for aiding modeling making use of a modeling language. The model editing assistance method is characterized in that the model editing assistance method comprises: determining whether or not there are similar elements which are elements referring to the same class and having different attributes or attribute values in an input model description; extracting an attribute shared by the similar elements extracted in accordance with a result of the determination to serve as a common class attribute of a group comprising the similar elements; generating derived classes inheriting the extracted common class attribute and associating the derived classes with their respective extracted similar elements; setting concrete attribute values of the generated derived classes at values which are described as attribute values of the corresponding similar elements; and replacing a class referred to by the extracted similar elements with the derived classes, the concrete attribute values of which have been set.

In addition, the model editing assistance method according to the present invention may be characterized in that the model editing assistance method comprises: searching for a predefined attribute which is an attribute defined in advance for a certain referenced class when describing an element referring to the class; generating a subclass of a certain referenced class when changing the value of the predefined attribute included in attributes of elements referring to the referenced class in a model description to serve as an attribute of the referenced class; and generating a model element referring to a generated subclass for a described element.

A model editing assistance program according to the present invention is a model editing assistance program for aiding modeling making use of a modeling language. The model editing assistance program is characterized in that the model editing assistance program is a program to be executed by a computer to carry out: repetitively referenced class determination processing for determining whether or not there are similar elements which are elements referring to the same class and having different attributes or attribute values in an input model description; common class attribute extraction processing for extracting an attribute shared by the similar elements extracted in accordance with a result of the determination as a common class attribute of a group comprising the similar elements; derived class generation processing for generating derived classes inheriting the common class attribute extracted in the common class attribute extraction processing and associating the derived classes with their respective extracted similar elements; attribute value determination processing for setting concrete attribute values of the derived classes generated in the derived class generation processing at values which are described as attribute values of the corresponding similar elements; and referenced class replacement processing for replacing the class referred to by the extracted similar elements with the derived classes, the concrete attribute values of which have been set in the attribute value determination processing.

In addition, the model editing assistance program according to the present invention may be characterized in that the model editing assistance program is a program to be executed by a computer to carry out: predefined attribute search processing for searching for a predefined attribute which is an attribute defined in advance for a certain referenced class when describing an element referring to the class; subclass generation processing for generating a subclass of a certain referenced class when changing the value of the predefined attribute included in attributes of elements referring to the referenced class in a model description to serve as an attribute of the referenced class; and model element generation processing for generating a model element referring to a subclass generated in the subclass generation processing for a described element.

### Advantageous Effects of the Invention

In accordance with the present invention, even a model maker not well versed in a modeling language such as SysML is made capable of constructing a model having a correct structure and a load borne by the model maker is also reduced as well.

### BRIEF DESCRIPTION OF THE DRAWINGS

FIG. 1 It depicts a block diagram showing a typical configuration of a model editing assistance device according to a first exemplary embodiment.

FIG. 2 It depicts an explanatory diagram showing a typical model described in the model editing assistance device.

FIG. 3 It depicts an explanatory diagram showing a typical common class attribute extracted from a model.

FIG. 4 It depicts a flowchart showing typical operations carried out by the model editing assistance device according to the first exemplary embodiment.

FIG. 5 It depicts an explanatory diagram showing a typical model obtained as a result of processing carried out by referenced class replacing means 105.

FIG. 6 It depicts a class hierarchy diagram showing a typical class hierarchy depicting relations associating generated derived classes with a parent class.

FIG. 7 It depicts a block diagram showing a typical configuration of a model editing assistance device according to a second exemplary embodiment.

FIG. 8 It depicts an explanatory diagram showing a typical model display obtained as a result of processing carried out by model displaying method conversing means 202.

FIG. 9 It depicts a class hierarchy diagram showing a typical class hierarchy depicting relations associating derived classes generated for a certain interface name with a parent class.

FIG. 10 It depicts a block diagram showing a typical configuration of a model editing assistance device according to a third exemplary embodiment.

FIG. 11 It depicts an explanatory diagram showing typical model editing operations carried out by the user and typical models obtained as a result of the model editing operations.

FIG. 12 It depicts an explanatory diagram showing a typical model display obtained as a result of processing carried out by model displaying method conversing means in another example of the third exemplary embodiment.

FIG. 13 It depicts a class hierarchy diagram showing a typical class hierarchy depicting relations associating a subclass generated for a certain interface name with a parent class and a predefined class.

FIG. 14 It depicts a block diagram showing an outline of the present invention.

FIG. 15 It depicts a block diagram showing another typical configuration of the model editing assistance device according to the present invention.

### DESCRIPTION OF EMBODIMENTS

### First Exemplary Embodiment

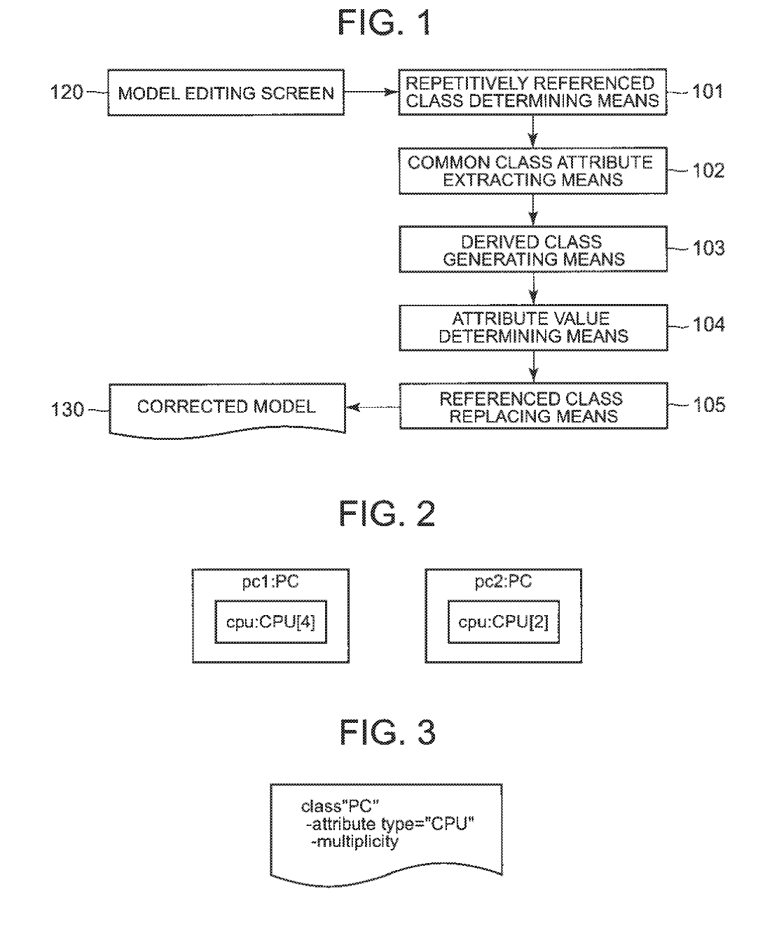

An exemplary embodiment of the present invention is explained by referring to diagrams as follows. FIG. 1 is a block diagram showing a typical configuration of a model editing assistance device according to a first exemplary embodiment.

The model editing assistance device shown in FIG. 1 comprises a model editing screen 120, repetitively referenced class determining means 101, common class attribute extracting means 102, derived class generating means 103, attribute value determining means 104 and referenced class replacing means 105.

The model editing screen 120 provides the user with an interface used for editing a model. The model editing screen 120 is implemented by typically displaying a model editor (such as SysML) making use of an ordinary modeling tool on a display apparatus such as a display unit. It is to be noted that the model editing screen 120 serving as a configuration element of the model editing assistance device includes a control section for controlling information of a screen displayed on the display apparatus and the screen. If the expression “model editing screen 120” functioning as an operation actor is used in the following description, the model editing screen 120 implies a control program for controlling the model editing screen displayed on the display apparatus or an information processing apparatus (such as a CPU) which operates in accordance with the program.

In this case, to put it more concretely, a model is a design drawing of typically a system described by making use of a modeling language such as SysML. FIG. 2 is an explanatory diagram showing a typical model described in the model editing assistance device. The example shown in FIG. 2 is a system model including two model elements pc1 and pc2 (classes or components) which each serve as a part. In addition, in the model shown in FIG. 2, both the model elements pc1 and pc2 refer to a PC class. However, the multiplicities of the parts cpu included therein are different from each other.

The repetitively referenced class determining means 101 carries out processing to determine whether or not there are similar elements in the model edited by the model editing screen 120 and extract the similar elements from the model. To put it concretely, for parts and values included internally in two parts referring to the same class, their types and their attribute values may be different from each other. In this case, the repetitively referenced class determining means 101 determines that the two parts are similar elements and extracts the common class referred to by the two parts as a repetitively referenced class. It is to be noted that, if the number of parts referring to the same class and internally including parts and values having types and attribute values different from each other is 2 or greater, the repetitively referenced class determining means 101 extracts the two or more parts as similar elements referring to the repetitively referenced class.

That is to say, the repetitively referenced class determining means 101 is capable of determining whether or not there is an element group (similar elements) which internally includes elements and element attributes different from each other in spite of reference to the same class and has an incorrect structure. For example, pc1 and pc2 described in the model shown in FIG. 2 refer to the same PC class. Since the multiplicities of the parts cpu included internally therein are different from each other, however, pc1 and pc2 are determined as similar elements and the PC class referred to by pc1 and pc2 is extracted as a repetitively referenced class.

The common class attribute extracting means 102 extracts information on an attribute as a common class attribute from the repetitively referenced class extracted by the repetitively referenced class determining means 101. An example of the information on an attribute is a property. The information on an attribute is information shared as common information by repetitively referenced classes. To put it concretely, the common class attribute extracting means 102 extracts elements (referred to hereafter as internal elements) having a common type from elements (parts or values) described inside the similar elements. In addition, the common class attribute extracting means 102 takes information other than concrete attribute values of the internal elements as a common class attribute of the repetitively referenced class. That is to say, the common class attribute is information indicating what type and what attribute are the type and attribute of the part and the value which are common to the similar elements.

In the model shown in FIG. 2 for example, the type of the part cpu included in the similar elements pc1 and pc2 as a part common to the similar elements pc1 and pc2 is a CPU. Since the part cpu has an attribute referred to as a multiplicity, the description indicates that the PC class includes parts having the CPU type and an attribute referred to as a multiplicity as a common class attribute extracted from the model. An example of the common class attribute extracted from the model in this way is shown in FIG. 3.

In the example shown in FIG. 3, ‘attribute type=’ prescribes the type of the attribute. In addition, ‘multiplicity’ described beneath it indicates that there are a number of such attributes. That is to say, ‘multiplicity’ indicates that it has an attribute referred to as a multiplicity.

The derived class generating means 103 carries out processing to generate a derived class for each similar element. This derived class is a class inheriting the common class attribute extracted by the common class attribute extracting means 102. As described above, the derived class generating means 103 generates a derived class for each similar element. This derived class has information representing the type and attribute of an internal element included in a similar element. As explained above, the type and the attribute are extracted as a common class attribute. For example, from the model shown in FIG. 2, for the similar element pc1, the derived class generating means 103 generates a derived class PC1 inheriting the common class attribute shown in FIG. 3 and, by the same token, for the similar element pc2, the derived class generating means 103 generates a derived class PC2 inheriting the common class attribute shown in FIG. 3.

The attribute value determining means 104 carries out processing to determine a concrete attribute value of an internal element included in the derived class generated by the derived class generating means 103. To put it concretely, the attribute value determining means 104 carries out processing to assign an attribute value set in a similar element associated with the derived class as the concrete attribute value of an internal element included in the generated derived class. By carrying out this processing, each of the generated derived classes can be provided with information representing the concrete attribute value of the internal element in accordance with the similar element in addition to the common class attribute.

For example, for the internal element of the derived class PC1 generated for the similar element pc1 as a derived class having the CPU type, the multiplicity of the cpu part described inside the similar element pc1 is set at 4. By the same token, for the internal element of the derived class PC2 generated for the similar element pc2 as a derived class having the CPU type, the multiplicity of the cpu part described inside the similar element pc2 is set at 2.

The referenced class replacing means 105 carries out processing to replace classes referred to by similar elements with derived classes, the concrete attribute values of internal elements of which have been determined by the attribute value determining means 104. To put it concretely, the referenced class replacing means 105 replaces each of classes referred to by similar elements with one of derived classes, the concrete attribute values of internal elements of which have been determined by the attribute value determining means 104.

According to this exemplary embodiment, the model editing screen 120 (including screen controlling means) is implemented by a display apparatus and an information processing apparatus (such as a CPU) operating in accordance with a program. In addition, each of the repetitively referenced class determining means 101, the common class attribute extracting means 102, the derived class generating means 103, the attribute value determining means 104 and the referenced class replacing means 105 is implemented by an information processing apparatus (such as a CPU) operating in accordance with a program. It is to be noted that a plurality of such information processing apparatus can be employed to serve as apparatus each used for carrying out one of functions typically in a distributed processing environment.

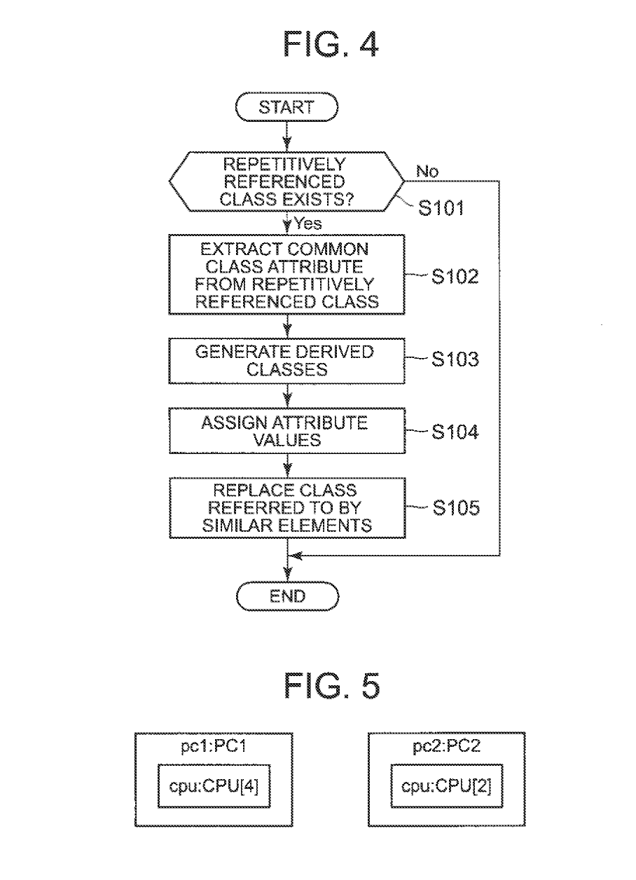

Next, operations carried out by the model editing assistance device according to this exemplary embodiment are explained by referring to a flowchart shown in FIG. 4. FIG. 4 is a flowchart showing typical operations carried out by the model editing assistance device according to this exemplary embodiment.

First of all, the typical flowchart shown in FIG. 4 begins with a step S101 at which the repetitively referenced class determining means 101 receives a model edited by making use of the model editing screen 120 and, from the edited model, the repetitively referenced class determining means 101 determines whether or not there is a repetitively referenced class. If it is determined that there is a repetitively referenced class, the flowchart continues to a step S102 at which the common class attribute extracting means 102 extracts a common class attribute. The common class attribute is information on an attribute defined as an attribute common to similar elements referring to the extracted repetitively referenced class. Then, at the next step S103, the derived class generating means 103 generates a derived class inheriting the common class attribute extracted by the common class attribute extracting means 102 for each of the similar elements referring to the repetitively referenced class. Subsequently, at the next step S104, the attribute value determining means 104 assigns a value defined for each of elements referring to the repetitively referenced class serving as the extraction source of the common class attribute of the derived classes to serve as a concrete attribute value of every derived class generated by the derived class generating means 103. Then, at the next step S105, the referenced class replacing means 105 replaces the class referred to by the elements referring to the repetitively referenced class with the derived classes for which the values defined for the elements referring to the repetitively referenced class have been assigned by the attribute value determining means 104 at the step S104.

FIG. 5 is an explanatory diagram showing a typical model obtained as a result of processing carried out by the referenced class replacing means 105. To be more specific, FIG. 5 shows an example obtained after the referenced class replacing means 105 has carried out processing to replace the referenced classes for the model shown in FIG. 2. As shown in FIG. 5, in the model shown in FIG. 2, the referenced class pc1 is replaced with a derived class PC1 with the multiplicity set at 4 whereas the referenced class pc2 is replaced with a derived class PC2 with the multiplicity set at 2.

As described above, in accordance with this exemplary embodiment, when describing a part having a nested structure in a modeling work making use of SysML, the model editing assistance device carries out processing to extract a model mismatching point considered to have been caused by the fact that the description shown in the figure is different from the structure of the model and, then, automatically corrects the structure of the model to a structure intended by the model maker. Thus, the model editing assistance device is capable of constructing a model having the correct structure without imposing a load on the model maker.

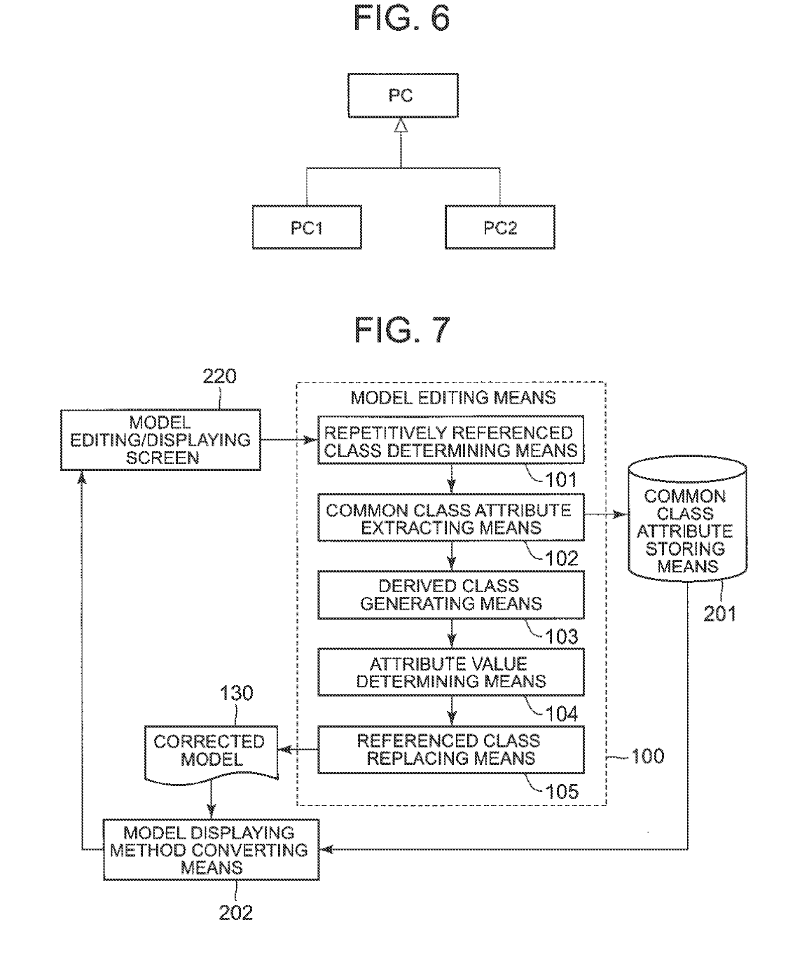

In addition, the model editing assistance device automatically carries out operations to generate derived classes and replaces referenced classes with the derived classes so that a parent class serving as an inheritance origin can be determined. Thus, an object table or the like can be used to record a parent class from which a derived class has been generated. A class hierarchy diagram like one shown in FIG. 6 is typically used to show relations associating automatically generated derived classes with a parent class (which is the repetitively referenced class serving as the origin of the derived classes). Thus, the model editing assistance device is capable of displaying a structure close to what is described by the user itself (a structure intended by the user is implied) without making the model maker (or, particularly, an inexperienced model maker) confused.

### Second Exemplary Embodiment

Next, a second exemplary embodiment of the present invention is explained. FIG. 7 is a block diagram showing a typical configuration of a model editing assistance device according to a second exemplary embodiment. In comparison with the first exemplary embodiment shown in FIG. 1, the model editing assistance device shown in FIG. 7 further has common class attribute storing means 201 and model displaying method converting means 202. In addition, the model editing assistance device shown in FIG. 7 is also different from the model editing assistance device shown in FIG. 1 in that the model editing assistance device shown in FIG. 7 includes a model editing/displaying screen 220 in place of the model editing screen 120. It is to be noted that, in the case of the second exemplary embodiment, model editing means 100 shown in FIG. 7 is means for carrying out the same operations as the repetitively referenced class determining means 101, the common class attribute extracting means 102, the derived class generating means 103, the attribute value determining means 104 and the referenced class replacing means 105 which are employed in the first exemplary embodiment.

The model editing/displaying screen 201 provides an interface with the user. This interface allows the user to edit a model and recognize the edited model. It is to be noted that the model editing/displaying screen 201 serving as a configuration element of the model editing assistance device includes a control section for controlling information of a screen displayed on the display apparatus and the screen. If the expression “model editing/displaying screen 201” functioning as an operation actor is used in the following description, the model editing/displaying screen 201 implies a control program for controlling the model editing/displaying screen displayed on the display apparatus or an information processing apparatus (such as a CPU) which operates in accordance with the program.

The common class attribute storing means 201 is a recording medium such as a magnetic disc or an optical disc. The common class attribute storing means 201 is used for storing common class attributes as metadata. As described before, the common class attribute is an attribute extracted by the common class attribute extracting means 102. The common class attribute storing means 201 is used for storing a common class attribute extracted from a repetitively referenced class by associating the attribute with typically a name extracted from a model as the name of the repetitively referenced class. The common class attributes include attributes defined as attributes common to parts (similar elements) referring to the repetitively referenced class, information on the similar elements and information on derived classes each generated for one of the similar elements. The common class attributes are stored in the common class attribute storing means 201 as common class information according to the present invention. In the following description, the name stored in the common class attribute storing means 201 as the name of the repetitively referenced class serving as a common class is referred to as a common class name.

The referenced class replacing means 105 employed in the model editing means 100 replaces a class referred to by a similar element with a derived class of a common class attribute. When the similar element is displayed on the model editing/displaying screen 220 by the model displaying method converting means 202, the similar element has been stored in the common class attribute storing means 201 as a referenced class name of the similar element instead of a post-replacement derived class name. The model displaying method converting means 202 carries out processing to display a common class name serving as the inheritance origin of the derived class. That is to say, the model displaying method converting means 202 coverts the referenced class name of a plurality of displayed similar elements so as to particularly display the fact that the class referred to by the similar elements inherits a certain common class. It is to be noted that, if only information on the common class attribute is stored in the common class attribute storing means 201, on the basis of the common class attribute, the model displaying method converting means 202 detects an element having the common class attribute from the model and, by assuming that the referenced class is a derived class used by the referenced class replacing means 105 as a replacement class, detects the class serving as the inheritance origin as a common class.

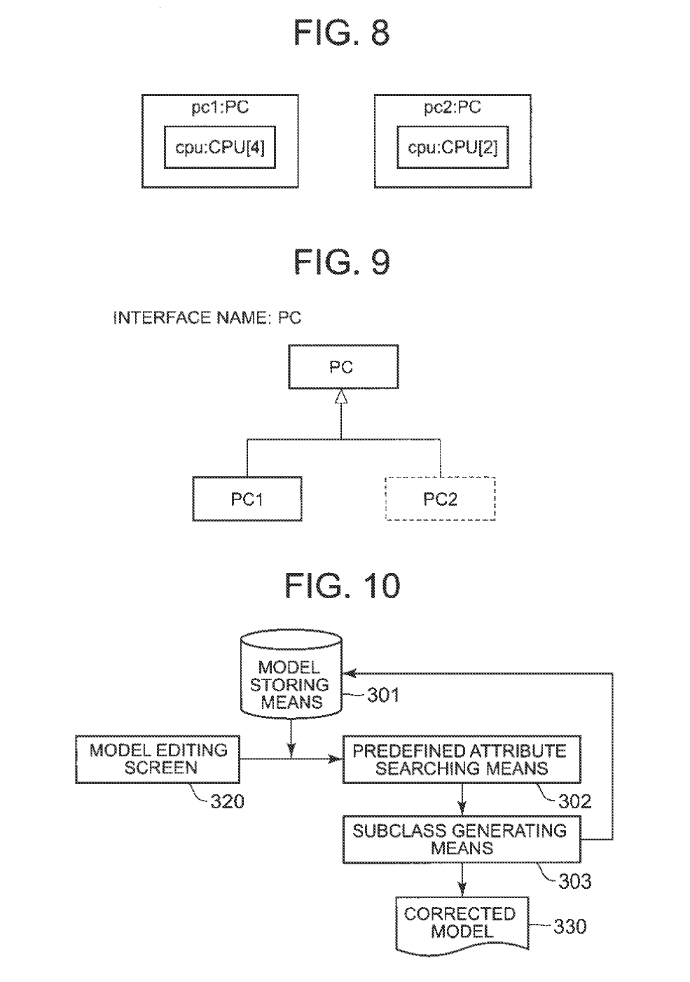

FIG. 8 is an explanatory diagram showing a typical model display obtained as a result of conversion processing carried out by the model displaying method conversing means 202. As shown in FIG. 8, as referenced classes pc1 and pc2 for example, the model displaying method converting means 202 displays a common class name PC stored in the common class attribute storing means 201 as the inheritance origin of a derived class instead of displaying a referenced class on the actual model (that is, instead of displaying the derived class used by the referenced class replacing means 105 as a replacement class).

Note that, to say only for the processing carried out by the model displaying method converting means 202 to change the referenced class name, even if model internal information (such as information indicating which class is being referred to) does not exist, it is sufficient to know a common class to which the information is linked. For example, it is possible to provide an exemplary embodiment in which the model editing means 100 is implemented by another apparatus and its resulting information (information on a common class shared with the corrected model) is acquired in order to convert the model displaying method. In such a case, the model editing means 100 can be eliminated. It is to be noted that the common class attribute storing means 201 can be used for storing a derived class used by the referenced class replacing means 105 as a replacement class and a common class serving as the origin of the derived class by associating the derived class and the common class with each other. In addition, for example, it is possible to provide an exemplary embodiment in which the repetitively referenced class determining means 101 and the common class attribute extracting means 102 are provided. In such an exemplary embodiment, from information on an input corrected model, a relation associating a common class according to the present invention with a derived class of the common class is detected and the model displaying method is changed.

In the second exemplary embodiment, the model editing assistance device carries out processing to store an extracted common class attribute in advance in a memory as metadata and, as a class referred to by similar elements, display an interface name instead of displaying a model with the structure thereof corrected. Then, a model with the displaying method changed in the processing is displayed through a model editing screen. Thus, without requiring the model maker to be aware of the fact that the structure of the model has been changed, it is possible to further display a drawing matching the intuitive sense of the model maker. As a result, it is possible to prevent an inexperienced modeler from being confused.

It is to be noted that the model editing assistance device may indicate the fact that an interface name is being displayed in place of the actual referenced class as shown in FIG. 8 typically by underlining the converted common class names, coloring the names or inserting comments in order to show some differences. In such a case, the model editing assistance device is capable of preventing an inexperienced modeler from being confused due to the fact that the description of the drawing and the structure of the model are different from each other. In addition, in accordance with a predetermined operation (such as an on mouse or mouse clicking) carried out on a display of a referenced class replaced with an interface name for example, the model editing assistance device may display a class hierarchy diagram centered at a derived class like one shown in FIG. 9. It is to be noted that FIG. 9 is a typical class hierarchy diagram displayed after a predetermined operation has been carried out on the interface name PC displayed as a class referred to by a part pc1. It is also to be noted that, since the model editing assistance device displays a class hierarchy diagram, the model maker is capable of easily comprehending not only a relation associating a derived class with a parent class, but also the existence of a derived class assigned to another similar element (that is, the existence of a part having some different attributes).

### Third Exemplary Embodiment

Next, a second exemplary embodiment of the present invention is explained. FIG. 10 is a block diagram showing a typical configuration of a model editing assistance device according to the third exemplary embodiment. The model editing assistance device shown in FIG. 10 comprises a model editing screen 320, model storing means 301, predefined attribute searching means 302 and subclass generating means 303.

The model editing screen 320 can be configured to be identical with the model editing screen 120 employed in the first exemplary embodiment. Note that, in the first and second exemplary embodiments, it is assumed that, during operations carried out to describe a drawing of a model on a modeling tool such as an editor and convert the model into a formal structure expressed by a modeling language such as UML or SysML, a repetitive referenced class is extracted from information on the model described in the drawing and derived classes are generated from the repetitive referenced class by taking the repetitive referenced class as a common class. In the case of the third exemplary embodiment, on the other hand, it is assumed that, in a state wherein a model has been existing from the beginning, a modeling tool such as an editor is used in order to edit the drawing of the model (that is, in order to create a new drawing or add new portions to the drawing).

The model storing means 301 is a recording medium such as a magnetic disc or an optical disc and is used for storing a described model. In this case, the model includes a hierarchical structure of typically blocks and/or classes which are each configuration elements described in the drawing and/or includes an inclusion relation.

When newly describing a model element such as a part referring to a class stored in the model storing means 301, the predefined attribute searching means 302 carries out processing to search for an attribute defined in the referenced class and extract the attribute. In the following description, a newly described model element is referred to as a new model element.

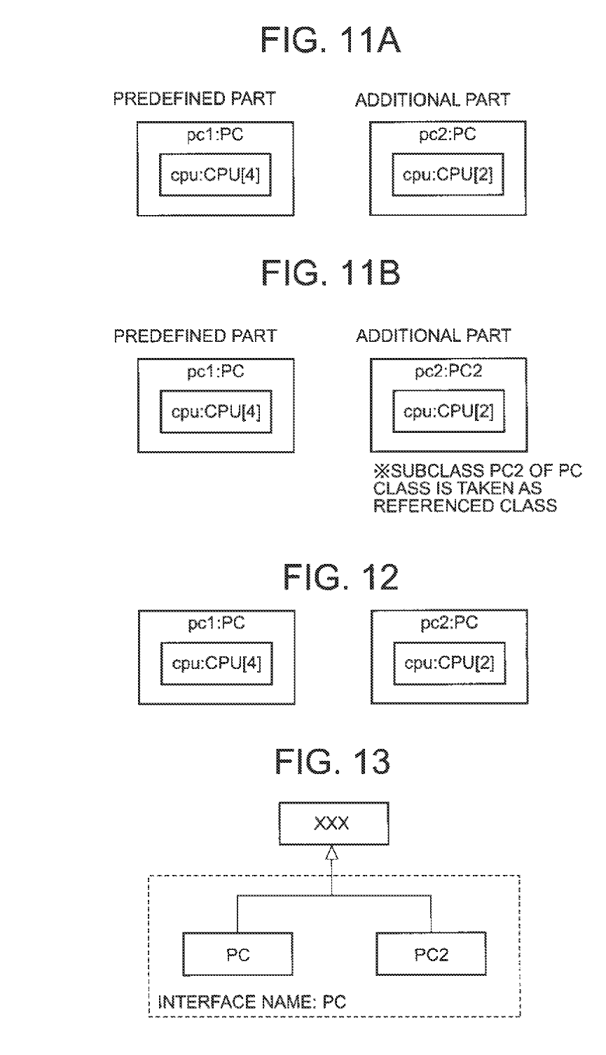

FIG. 11(a) is an explanatory diagram showing an example of model editing operations carried out by the user. In the example shown in FIG. 11(a), if a part pc1 has been described for example, the model storing means 301 is used for storing information which indicates that a PC class includes a part having a CPU type and a multiplicity of 4. In this state, if a part pc2 which is a new model element referring to the same PC class has been described, the predefined attribute searching means 302 extracts information on an attribute (CPU type and a multiplicity of 4) defined in the PC class.

The subclass generating means 303 compares the attribute extracted by the predefined attribute searching means 302 with the attribute of the new model element. If the compared attributes are found to be different from each other, the subclass generating means 303 generates a subclass of a class (that is, a class referred to by the new model element) stored in the model storing means 301 and sets an attribute described in the new model element as an attribute of the subclass. For example, in accordance with the predefined attribute searching means 302, the PC class includes a part having a CPU type and a multiplicity of 4. However, a part having the CPU type as described inside the part pc2 which is a new model element in the example shown in FIG. 11(a) has a multiplicity of 2. Thus, the subclass generating means 303 generates a subclass (in the case of this example, a PC2 subclass) of the PC class and sets a part having the CPU type and a multiplicity of 2 as an attribute of the subclass.

FIG. 11(b) is an explanatory diagram showing a typical model obtained as a result of model editing according to this exemplary embodiment. As shown in FIG. 11(b), as a description of a part pc2, the subclass generating means 303 carries out processing to replace a referenced class by taking a generated subclass as a referenced class.

It is to be noted that, in this exemplary embodiment, if the type of a class already existing in a model has been referenced as the type of another class, a class generated from a class existing from the beginning is referred to as a subclass in order to distinguish a subclass from a derived class for the first and second exemplary embodiments. This is because the generation origin of a subclass is different from the generation origin of a derived class. It is to be noted that, in this exemplary embodiment, a class serving as the base of a subclass is described from the beginning in the model.

In this exemplary embodiment, when setting a concrete attribute in a new model element, if an attempt is made to mistakenly change an attribute of a class having an attribute already defined in the model storing means 301, the model editing assistance device generates a subclass of the class and sets the new model element as an attribute included in the subclass. Thus, the model editing assistance device is capable of compensating for inadequate understanding of an inexperienced modeler, which is caused by the fact that the description of the drawing and the structure of the model are different from each other. As a result, the model editing assistance device is capable of carrying out operations (modeling) as intended by the model maker.

If operating not in accordance with this exemplary embodiment for example, an operation to change the multiplicity of the CPU of the part pc2 shown in the drawing is regarded as an incorrect operation because another multiplicity has already been set in the model so that the operation cannot be carried out. In the case of this exemplary embodiment, however, the model editing assistance device automatically generates a subclass and sets a value described in the drawing as an attribute of the subclass so that the model editing assistance device is capable of changing the multiplicity of the CPU and showing the changed multiplicity to the user.

Thus, it is possible to carry out an operation (modeling) matching the intuitive sense of the model maker and enable even an inexperienced modeler to construct a correct model.

Note that, also in this exemplary embodiment, in the same way as the second exemplary embodiment, it is possible to change the name of a class referred to by the new model element to an interface name and display the interface name instead of displaying the name of the actual class (that is, instead of displaying the name of a subclass automatically created by the system). In such a case, it is nice to further provide model display method converting means. In addition, it is nice to also provide subclass information storing means used for storing information linking the subclass generated by the subclass generating means 303 to a predefined class serving as an origin from which the subclass is generated. In such a case, for example, for a part taking a subclass stored in the subclass information storing means as a referenced class, the model editing assistance device typically changes its referenced class name to an interface name and displays the interface name.

As an interface name, for example, an original referenced class name set at an operation time can be used (Refer to FIG. 12). In addition, a newly defined name can also be used. Note that, in such a case, in the same way as the second exemplary embodiment, it is more desirable to display the interface name by showing some differences so that the displayed interface name is known to be an interface name. It is to be noted that FIG. 13 is a typical class hierarchy diagram showing a class hierarchy for a case in which a predetermined operation has been carried out for the interface name PC displayed as a class referred to by the part pc2. It is to be noted that, by displaying a class hierarchy diagram, the model maker is capable of easily comprehending not only a relation associating a generated subclass with a parent class, but also the existence of a predefined class serving as the origin from which the subclass is generated (that is, the existence of a part having some different attributes).

The exemplary embodiments of the present invention have been described so far by referring to diagrams. However, model editing assistance devices provided by the present invention are by no means limited to the exemplary embodiments. Instead, the model editing assistance devices that can be provided by the present invention are model editing assistance devices included in an invention range implementing a variety of corrections obtained from the configurations of the exemplary embodiments and a variety of changes also obtained from the configurations of the exemplary embodiments.

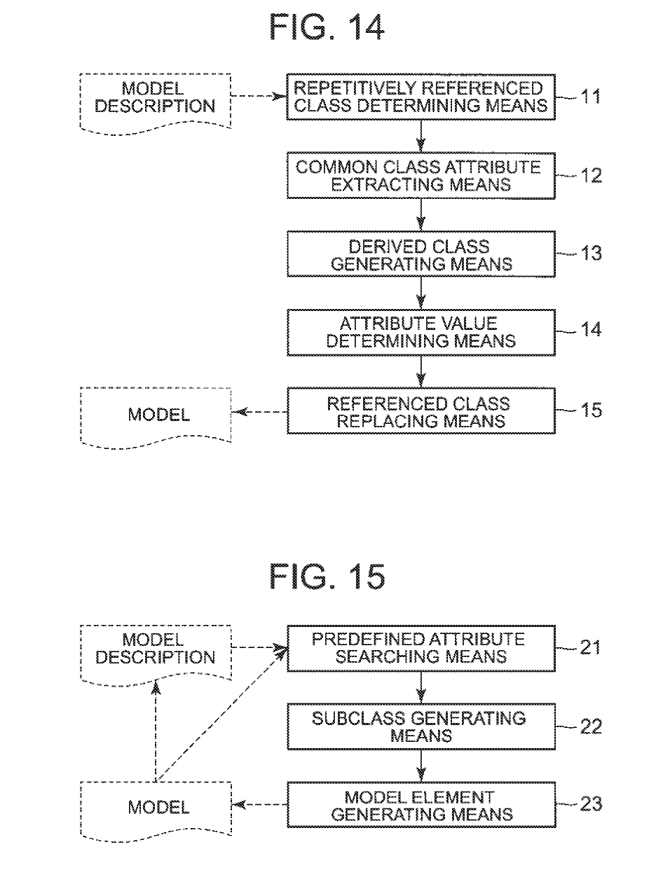

Next, an outline of the present invention is explained. FIG. 14 is a block diagram showing the outline of the present invention. A model editing assistance device shown in FIG. 12 comprises repetitively referenced class determining means 11, common class attribute extracting means 12, derived class generating means 13, attribute value determining means 14 and referenced class replacing means 15.

The repetitively referenced class determining means 11 (such as the repetitively referenced class determining means 101) determines whether or not an input model description includes similar elements which are elements referring to the same class and having different attributes or attribute values. It is to be noted that the model description is information provided in a notation state to serve as information on a model to be created. The information is typically a drawing displayed on a modeling tool.

The common class attribute extracting means 12 (such as the common class attribute extracting means 102) extracts an attribute, which is shared by the similar elements extracted by the repetitively referenced class determining means 11 in accordance with a result of the determination carried out by the repetitively referenced class determining means 11, as a common class attribute of a group consisting of the similar elements.

The derived class generating means 13 (such as the derived class generating means 103) generates derived classes inheriting the common class attribute extracted by the common class attribute extracting means 12 and associates the derived classes with their respective extracted similar elements extracted by the repetitively referenced class determining means 11 in accordance with a result of the determination carried out by the repetitively referenced class determining means 11.

The attribute value determining means 14 (such as the attribute value determining means 104) sets concrete attribute values of the derived classes generated by the derived class generating means 13 at values which are described as attribute values of the corresponding similar elements.

The referenced class replacing means 15 (such as the referenced class replacing means 105) replaces a class referred to by the similar elements extracted by the repetitively referenced class determining means 11 in accordance with a result of the determination carried out by the repetitively referenced class determining means 11 with the derived classes, the concrete attribute values of which have been set by the attribute value determining means 14.

For example, as a common class attribute, the common class attribute extracting means 12 may extract the types of elements common to classes referred to by the similar elements and information on the attributes of the elements.

In addition, as shown in none of the figures, the model editing assistance device may be provided with model displaying method conversing means for converting a method for displaying a model including elements having referenced classes replaced by the referenced class replacing means 15 into notations representing contents different from the structure of the model.

In addition, it is possible to provide common class attribute storing means for storing a common class attribute extracted by the common class attribute extracting means 12 from a model. In such a configuration, the model displaying method conversing means may convert the method for displaying a model having referenced classes replaced by the referenced class replacing means 15 on the basis of the common class attribute.

In addition, FIG. 15 is a block diagram showing another typical configuration of the model editing assistance device according to the present invention. The model editing assistance device shown in FIG. 15 comprises predefined attribute searching means 21, subclass generating means 22 and model element generating means 23.

When an element referring to a certain class has been described, the predefined attribute searching means 21 (such as the predefined attribute searching means 302) searches a predefined model structure for a predefined attribute and extracts the predefined attribute from the model structure. The predefined attribute is an attribute already defined for the referenced class.

When the value of a predefined attribute included in attributes of an element referring to a certain class to serve as a predefined attribute of the class in a description of a model is changed, the subclass generating means 22 (such as the subclass generating means 303) generates a subclass of the referenced class.

The model element generating means 23 (such as the subclass generating means 303) generates a model element referring to a subclass generated by the subclass generating means 22 for a described element.

The subclass generating means 22 may typically set the changed value of the predefined attribute as the attribute of the generated subclass.

By providing the configuration described above, when a specific class is referred to by a plurality of elements, the model editing assistance device is capable of extracting the type of the attribute of the class, that is, information serving as a common class attribute and automatically generating a derived class inheriting the common class attribute for each of the elements. In addition, the model editing assistance device is also capable of setting an attribute concrete values described for a plurality of elements as attribute values of these derived elements and replacing the class referred to by the elements with the derived classes. Thus, when an incorrect drawing is described as a model structure of SysML or the like, the structure of the model is corrected automatically in the model editing assistance device so that even an inexperienced modeler is capable of constructing a correct model without the need for the model editing assistance device to impose a load on the model maker.

In addition, the model editing assistance device is capable of storing the extracted common class attribute in a memory as metadata and displaying an interface name in place of the name of a generated derived class as a class referred to by elements. Thus, without making the model maker aware of the fact that the structure of the model has been changed, the model editing assistance device is capable of displaying a drawing matching the intuitive sense of the model maker. As a result, the model editing assistance device is capable of preventing the model maker (particularly, an inexperienced modeler) from getting confused.

In addition, when a new element is added to the model and a concrete attribute is set, in an attempt made to change the attribute of a class to a concrete attribute already defined, the model editing assistance device is capable of generating a subclass of the class and taking the new element as the attribute of the subclass. Thus, the model editing assistance device is capable of carrying out an operation (modeling) matching the intuitive sense of the model maker and enabling even an inexperienced modeler to construct a correct model.

The present invention has been explained above by describing exemplary embodiments and typical implementations. However, the present invention is by no means limited to the exemplary embodiments and the typical implementations. That is to say, a person skilled in the art is capable of making a variety of changes within the scope of the present invention to the configuration of the present invention and its details.

This specification claims a priority right based on Japanese Patent Application JP 2010-274655 filed on Dec. 9, 2010, the entire disclosure of which is incorporated herein by reference.

### INDUSTRIAL APPLICABILITY

In applications to perform modeling making use of a modeling language, the present invention can be well applied to an operation carried out to newly create a model from a drawing as well as an operation carried out to edit a model already created on a drawing.

### REFERENCE SIGNS LIST

100 . . . Model editing means
101 . . . Repetitively referenced class determining means
102 . . . Common class attribute extracting means
103 . . . Derived class generating means
104 . . . Attribute value determining means
105 . . . Referenced class replacing means
120 . . . Model editing screen
130 . . . Corrected model
220 . . . Model editing/displaying screen
201 . . . Common class attribute storing means
202 . . . Model displaying method converting means
301 . . . Model storing means
302 . . . Predefined attribute searching means
303 . . . Subclass generating means
11 . . . Repetitively referenced class determining means
12 . . . Common class attribute extracting means
13 . . . Derived class generating means
14 . . . Attribute value determining means
15 . . . Referenced class replacing means
21 . . . Predefined attribute searching means
22 . . . Subclass generating means
23 . . . Model element generating means

1. A model editing assistance device for aiding modeling making use of a modeling language, said model editing assistance device comprising:
a repetitively referenced class determining unit for determining whether or not there are similar elements which are elements referring to the same class and having different attributes or attribute values in an input model description;
a common class attribute extracting unit for extracting an attribute shared by said similar elements extracted in accordance with a result of said determination carried out by said repetitively referenced class determining unit to serve as a common class attribute of a group comprising said similar elements;
a derived class generating unit for generating derived classes inheriting said common class attribute extracted by said common class attribute extracting unit and associating said derived classes with their respective extracted similar elements;
an attribute value determining unit for setting concrete attribute values of said derived classes generated by said derived class generating unit at values which are described as attribute values of said corresponding similar elements; and
a referenced class replacing unit for replacing said class referred to by said extracted similar elements with said derived classes, the concrete attribute values of which have been set by said attribute value determining unit.

2. The model editing assistance device according to claim 1, wherein, as said common class attribute, said common class attribute extracting unit extracts information on the type of a common element shared by classes each referred to by said similar elements and information on the attribute of said common element.

3. The model editing assistance device according to claim 1, said model editing assistance device comprising a model displaying method converting unit for converting a method for displaying a model including an element, a class referred to by which has been replaced by said referenced class replacing unit, into notation representing contents different from the structure of said model.

4. The model editing assistance device according to claim 3, said model editing assistance device comprising a common class attribute storing unit for storing said common class attribute extracted by said common class attribute extracting unit from a model,
wherein said model displaying method converting unit converts said method for displaying said model including an element, a class referred to by which has been replaced, on the basis of said common class attribute.

5. A model editing assistance device for aiding modeling making use of a modeling language, said model editing assistance device comprising:
a predefined attribute searching unit for searching for a predefined attribute which is an attribute defined in advance for a certain referenced class when describing an element referring to said class;
a subclass generating unit for generating a subclass of a certain referenced class when changing the value of said predefined attribute included in attributes of elements referring to said referenced class in a model description to serve as an attribute of said referenced class; and
a model element generating unit for generating a model element referring to a subclass generated by said subclass generating unit for a described element.

6. The model editing assistance device according to claim 5, wherein said subclass generating unit sets a changed value of said predefined attribute as an attribute of said generated subclass.

7. A model editing assistance method for aiding modeling making use of a modeling language, said model editing assistance method comprising:
determining whether or not there are similar elements which are elements referring to the same class and having different attributes or attribute values in an input model description;
extracting an attribute shared by said similar elements extracted in accordance with a result of said determination to serve as a common class attribute of a group comprising said similar elements;
generating derived classes inheriting said extracted common class attribute and associating said derived classes with their respective extracted similar elements;
setting concrete attribute values of said generated derived classes at values which are described as attribute values of said corresponding similar elements; and
replacing said class referred to by said extracted similar elements with said derived classes, the concrete attribute values of which have been set.

8. (canceled)

9. (canceled)

10. (canceled)
